(19) United States
(12) Patent Application Publication
(10) Pub. No.: US 2010/0266768 A1
(43) Pub. Date: Oct. 21, 2010

(54) METHOD OF DOPING AND APPARATUS FOR DOPING

(76) Inventor: Abu Samah Zuruzi, Singapore (SG)

Correspondence Address: FARJAMI & FARJAMI LLP, 26522 LA ALAMEDA AVENUE, SUITE 360, MISSION VIEJO, CA, 92691, US

(21) Appl. No.: 12/734,996

(22) PCT Filed: Aug. 27, 2008
(86) PCT No.: PCT/SG2008/000319

§ 371 Date: Jun. 8, 2010

(30) Foreign Application Priority Data
Dec. 11, 2007 (SG) 200718693-5

(51) Int. Cl. B05D 5/00; B05D 1/32; B05C 3/20; B05C 11/00

(52) U.S. Cl. 427/258; 427/256; 427/282; 118/401; 118/600

(57) ABSTRACT

A method of doping at least one element in an array of elements on a substrate is disclosed. The method comprises providing at least one microfluidic channel passing from a first location external of the at least one element to a second location in fluidic communication with the at least one element. A dopant fluid is passed through the at least one microfluidic channel to the at least one element for doping the at least one element. A corresponding apparatus is also disclosed.

### TECHNICAL FIELD

This invention relates to a method of doping and apparatus for doping and refers particularly, though not exclusively, to a method of doping at least one element in an array of elements on a substrate and apparatus for doping at least one element in an array of elements on a substrate.

### BACKGROUND

Current commercial sensing systems for gases use micrometer scale sensing elements. These sensing elements typically use ceramic based metal oxides which limit their sensitivity and other performance characteristics. Sub-micrometer scale materials generally have very high surface-to-volume ratios. Surface events such as adsorption of gaseous species can cause a drastic change in electrical conductivity, thereby affecting sensing capability. Use of discrete sub-micrometer scale metal oxides such as tin oxide nanotubes and nanowires results in a tremendous increase in sensitivity to gases such as carbon monoxide relative to the micrometer scale sensing element.

For applications in food and environmental monitoring, for example, arrays of sensing elements are required to collate data. Each sensing element in an array should have a unique response and sensitivity to a particular chemical species such as a gas. Individual sensing elements thus need to be modified differently.

To dope individual elements in a sensor array, currently, combinatorial techniques have to be used where dopants are selectively deposited into the metal oxides in high vacuum using magnetic and or electrical means. Using combinatorial techniques requires highly specialized equipment and materials, giving rise to significant costs. Also, these techniques are usually serial in nature, meaning that dopants can only be incorporated into one element at a time. Doping of an array will therefore take time. For manufacturing environments, this is not optimal.

### SUMMARY

According to an exemplary aspect there is provided a method of doping at least one element in an array of elements on a substrate, the method comprising:
providing at least one microfluidic channel passing from a first location external of the at least one element to a second location in fluidic communication with the at least one element; and
passing a dopant fluid through the at least one microfluidic channel to the at least one element for doping the at least one element.

There may be a first plurality of elements and a second plurality of microfluidic channels. At least one of the plurality of microfluidic channels may be for each of the plurality of elements of the plurality of elements. There may be a mask formed on the substrate. The at least one element may be formed on the substrate or the mask. The mask may be integral with the substrate. The at least one microfluidic channel may be in the mask or the substrate. The method may further comprise heating the at least one element when passing the dopant fluid through the at least one microfluidic channel to the at least one element for doping the at least one element. The heating may be by at least one heating element formed in at least one of the substrate and the mask. The at least one heating element may be adjacent the at least one element. There may be at least two microfluidic channels for each of the at least one elements. Each of the at least two microfluidic channels may be for supplying a different dopant fluid. The different dopant fluids may be supplied simultaneously and/or consecutively. The at least one microfluidic channel may be branched for supply of the dopant fluid to more than one location for each of the at least one elements.

According to another exemplary aspect there is provided apparatus for doping at least one element in an array of elements on a substrate, the apparatus comprising at least one microfluidic channel formed in the substrate, the at least one microfluidic channel passing from a first location external of the at least one element to a second location in fluidic communication with the at least one element; the at least one microfluidic channel being configured to pass a dopant fluid through the at least one microfluidic channel to the at least one element for doping the at least one element.

For the other exemplary aspect, the apparatus may further comprise at least one heating element formed in the substrate and being configured for heating the at least one element when passing the dopant fluid through the at least one microfluidic channel to the at least one element for doping the at least one element.

According to a further exemplary aspect there is provided apparatus for doping at least one element in an array of elements on a substrate, the apparatus comprising at least one heating element formed in the substrate and being configured for heating the at least one element when doping the at least one element.

For the further exemplary aspect the substrate may further comprise at least one microfluidic channel formed in the substrate, the at least one microfluidic channel passing from a first location external of the at least one element to a second location in fluidic communication with the at least one element; the at least one microfluidic channel being configured to pass a dopant fluid through the at least one microfluidic channel to the at least one element for doping the at least one element.

For the other and further exemplary aspects, there may be at least two microfluidic channels for each of the at least one elements. Each of the at least two microfluidic channels may be for supplying a different dopant fluid. The different dopant fluids may be able to be supplied simultaneously and/or consecutively. The at least one microfluidic channel may be branched for supply of the dopant fluid to more than one location for each of the at least one elements. There may be a first plurality of elements and a second plurality of microfluidic channels. At least one of the second plurality of microfluidic channels may be for each of the first plurality of elements of the plurality of elements. There may be a mask formed on the substrate. The at least one element may be formed on the mask or the substrate. The mask may be integral with the substrate. The at least one heating element may be adjacent the at least one element. Each element of the at least one elements may be a sensor. The at least one microfluidic channel may be in the mask. The at least one heating element may be formed in at least one of the substrate and the mask.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is a front perspective view from above of an exemplary embodiment;

FIG. 2 is a schematic horizontal cross-sectional view along the lines and in the direction of arrows 2-2 on FIG. 1; and

FIG. 3 is a schematic close-up plan view of the embodiment of FIG. 1;

FIG. 4 is a schematic close-up plan view of an alternative exemplary embodiment.

### DETAILED DESCRIPTION OF THE EXEMPLARY EMBODIMENTS

As shown in FIGS. 1 to 4, there is a mask 10 for doping sensor elements 12 in an array of sensor elements 12 on a substrate 14. The mask 10 has a series of microfluidic channels 16 formed therein. Alternatively or additionally, the microfluidic channels 16 may be formed in the substrate 14. Each microfluidic channel 16 passes from a first location 18 external of the relevant sensor element 12 to a second location 20 in fluidic communication with the sensor element 12. A dopant fluid for the sensor element 12 can be passed from a source of fluid (not shown) through the microfluidic channel 16 to sensor element 12 for doping the sensor element 12.

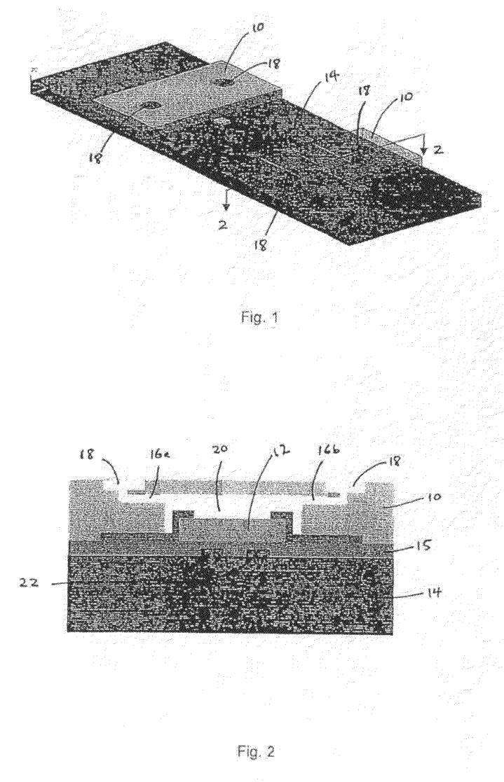

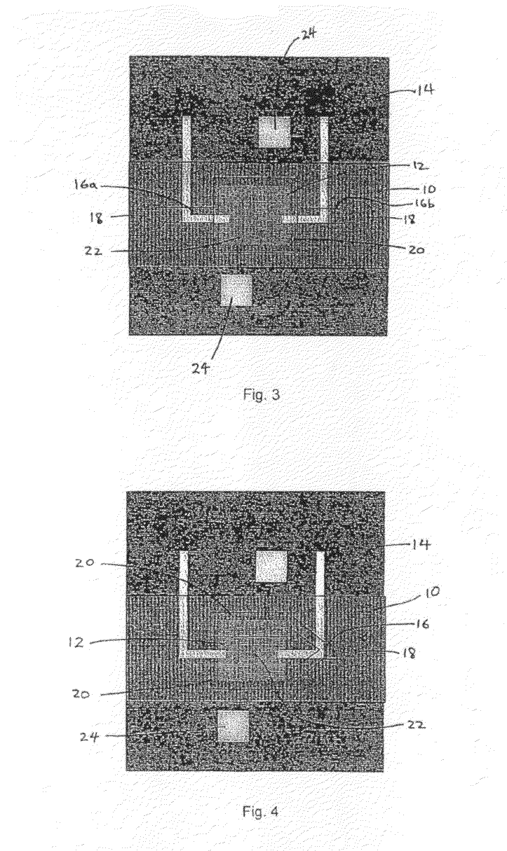

As shown in FIG. 1 there are only two sensor elements 12. There may be any suitable or required number of sensor elements 12 in the array. Each sensor element 12 will have at least one microfluidic channel 16 in communication therewith. If more than one dopant fluid is required for a particular sensor element 12, there may be two or more microfluidic channels 16a, 16b for that sensor element 12 as shown in FIGS. 2 and 3. The different dopant fluids may be supplied simultaneously and/or consecutively.

Depending on the material of the sensor element 12 and/or the required performance characteristics of the sensor element 12, the microfluidic channel 16 may be branched adjacent the sensor element 12 to provide the dopant fluid to more than one location of the sensor element 12, as shown in FIG. 4. The dopant supplied to the sensor elements 12 in the array may vary for individual, or groups of, sensor elements 12. If the same, the microfluidic channels 16 may be supplied from a common source, through common feed channels (not shown).

The width of the microfluidic channels 16 may range from about 500 micrometers to 5 micrometers. Delivery rates depend on the type of dopants and concentrations used. Dopants may be any elements that increase gas sensitivity, for example, europium, tin, calcium. Dopant concentration is typically in the millimolar to micromolar levels, depending on the amount of dopant to be incorporated which in turn is dependent on the application. The mask 10 is formed on the substrate 14. The substrate 14 preferably comprises an insulating layer 15, as shown in FIG. 2. Alternatively, the mask 10 may be integral with the substrate 14. The sensor elements 12 may be formed on the mask 10 or the substrate 14. The substrate 14 may be any suitable non-conducting material such as glass, silicon, and flexible polymer films. The mask 10 may be formed by any micromachining technique, for example, laser micromachining or build-up techniques such as selective laser sintering or stereo lithography.

There may be heating elements 22 formed on the substrate 14. The heating elements 22 may be located in the insulating layer 15 of the substrate 14. The heating elements 22 are for heating the sensor elements 12 when passing the dopant fluid through the microfluidic channels 16 to the sensor element 12 for doping the sensor elements 12. Heating assists the doping action as well as detection of chemicals during sensor operation. The heating elements 22 are below each sensor element 12 and have external contact pads 24 for electrical connections to the heating elements 22.

Heating is preferably confined to each sensor element 12. The heating elements 22 are preferably made of materials amenable to resistive heating, such as tungsten or silicides. Preferably, the heating elements 22 and heating contact pads 24 are placed as close as possible to reduce real estate and thereby cost. The power required as well as the heating temperature are dependent on the type of dopant used as well as the concentration of dopants dissolved in the fluid passing through the microfluidic channels 16.

Each sensor element 12 may be made of at least one semiconducting metal oxide, such as, for example, TiO₂ or other suitable metal oxides. The sensor elements 12 are preferably three-dimensionally interconnected nanostructures or three dimensionally nanoporous materials such as, for example, nanosponges.

Whilst there has been described in the foregoing description exemplary embodiments, it will be understood by those skilled in the technology concerned that many variations in details of design, construction and/or operation may be made without departing from the present invention as defined by the following claims.

1. A method of doping at least one element in an array of elements on a substrate, the method comprising: providing the substrate with the at least one element thereon, there being at least one microfluidic channel passing from a first location external of the at least one element to a second location in fluidic communication with the at least one element; and passing a dopant fluid through the at least one microfluidic channel to the at least one element for doping the at least one element.

2. A method as claimed in claim 1, wherein there are a first plurality of elements and a second plurality of microfluidic channels.

3. A method as claimed in claim 2, wherein at least one of the plurality of microfluidic channels is for each of the plurality of elements.

4. A method as claimed in claim 1 further comprising a mask formed on the substrate, the at least one element being formed on one of the mask and the substrate.

5. A method as claimed in claim 4, wherein the mask is integral with the substrate.

6. A method as claimed in claim 1 further comprising heating the at least one element when passing the dopant fluid through the at least one microfluidic channel to the at least one element for doping the at least one element.

7. A method as claimed in claim 6, wherein the heating is by at least one heating element formed in at least one of the substrate and the mask.

8. A method as claimed in claim 7, wherein the at least one heating element is adjacent the at least one element.

9. A method as claimed in claim 1, wherein there are at least two microfluidic channels for each of the at least one elements, each of the at least two microfluidic channels being for supplying a different dopant fluid.

10. A method as claimed in claim 9, wherein the different dopant fluids are supplied simultaneously and/or consecutively.

11. A method as claimed in claim 1, wherein the at least one microfluidic channel is branched for supply of the dopant fluid to more than one location for each of the at least one elements.

12. A method as claimed in claim 4, wherein the at least one microfluidic channel is formed in one of: the mask, and the substrate.

13. A doping apparatus to dope at least one element in an array of elements on a substrate, the apparatus comprising at least one microfluidic channel, the at least one microfluidic channel passing from a first location external of the at least one element to a second location in fluidic communication with the at least one element; the at least one microfluidic channel being configured to pass a dopant fluid through the at least one microfluidic channel to the at least one element for doping the at least one element.

14. Apparatus as claimed in claim 13 further comprising at least one heating element configured for heating the at least one element when passing the dopant fluid through the at least one microfluidic channel to the at least one element for doping the at least one element.

15. A doping apparatus to dope at least one element in an array of elements on a substrate, the apparatus comprising at least one heating element configured for heating the at least one element when doping the at least one element.

16. Apparatus as claimed in claim 15 further comprising at least one microfluidic channel, the at least one microfluidic channel passing from a first location external of the at least one element to a second location in fluidic communication with the at least one element; the at least one microfluidic channel being configured to pass a dopant fluid through the at least one microfluidic channel to the at least one element for doping the at least one element.

17. Apparatus as claimed in claim 13, wherein there are at least two microfluidic channels for each of the at least one elements, each of the at least two microfluidic channels being for supplying a different dopant fluid.

18. Apparatus as claimed in claim 17, wherein the different dopant fluids are able to be supplied simultaneously.

19. Apparatus as claimed in claim 17, wherein the different dopant fluids are able to be supplied consecutively.

20. Apparatus as claimed in claim 13, wherein the at least one microfluidic channel is branched for supply of the dopant fluid to more than one location for each of the at least one elements.

21. Apparatus as claimed in claim 13, wherein there are a first plurality of elements and a second plurality of microfluidic channels.

22. Apparatus as claimed in claim 21, wherein at least one of the second plurality of microfluidic channels is for each of the first plurality of elements.

23. Apparatus as claimed in claim 13, wherein a mask is formed on a substrate, the at least one element being formed on one of: the mask and the substrate.

24. Apparatus as claimed in claim 23, wherein the mask is integral with the substrate.

25. Apparatus as claimed in claim 14, wherein the at least one heating element is adjacent the at least one element.

26. Apparatus as claimed in claim 13, wherein each element of the at least one element is a sensor.

27. Apparatus as claimed in claim 23, wherein the at least one microfluidic channel is in one of: the mask, and the substrate.

28. Apparatus as claimed in claim 23, wherein the at least one heating element is in at least one of the substrate, and the mask.
